(19) United States
(12) Patent Application Publication
(10) Pub. No.: US 2024/0056794 A1
(43) Pub. Date: Feb. 15, 2024

(54) DOWNLOAD HANDLING OFA POOL OF SUBSCRIPTION PROFILES

(71) Applicant: Telefonaktiebolaget LM Ericsson (publ), Stockholm (SE)

(72) Inventors: Patrik SALMELA, Espoo (FI); Per STÅHL, Klagshamn (SE)

(73) Assignee: Telefonaktiebolaget LM Ericsson (publ), Stockholm (SE)

(21) Appl. No.: 18/267,964

(22) PCT Filed: Dec. 17, 2020
(86) PCT No.: PCT/EP2020/086645

§ 371 Date: Jun. 16, 2023

(51) Int. Cl. H04W 8/20

(52) U.S. Cl. CPC H04W 8/205

(57) ABSTRACT

There is provided mechanisms for handling download of a subscription profile from a pool of subscription profiles. The subscription profiles of the pool of subscription profiles are served by an MNO entity. A method is performed by a subscription management entity. The subscription management entity manages the pool of subscription profiles. The pool of subscription profiles has its own pool identifier. The method comprises obtaining a request from a communication device for download of one of the subscription profiles from the pool of subscription profiles. The method comprises enabling download to the communication device of one of the subscription profiles from the pool of subscription profiles. The method comprises filling up the pool of subscription profiles so that total number of subscription profiles in the pool of subscription profiles remains unchanged.

### TECHNICAL FIELD

Embodiments presented herein relate to a method, a subscription management entity, a computer program, and a computer program product for handling download of a subscription profile from a pool of subscription profiles. Embodiments presented herein further relate to a method, a mobile network operator entity, a computer program, and a computer program product for ordering a pool of subscription profiles.

### BACKGROUND

In general terms, an embedded-SIM (eSIM; where SIM is short for subscriber identity module or subscriber identification module), or embedded universal integrated circuit card (eUICC), or integrated universal integrated circuit card (iUICC), is a form of programmable SIM card that is embedded directly into a communication device. Hereinafter the terms eSIM, eUICC, and iUICC will be used interchangeably to denote such an embedded subscription profile. For the consumer variant of the eSIM, the communication device obtains information about a subscription profile to be downloaded. The information includes information about the provisioning server (such as an enhanced Subscription Manager Data Preparation (SM-DP+) server) currently holding the subscription profile and an identifier (such as a Matching ID) for the subscription profile in the provisioning server. The communication device then proceeds to connecting to the provisioning server for downloading the subscription profile. The Matching ID can be generated by the mobile network operator (MNO) serving the communication device or the provisioning server and should uniquely identify the subscription profile it points to. The information can be provided to the eSIM by the user/owner of the communication device through some form of user and/or network interface, such as from a Subscription Manager Discovery Server (SM-DS).

When the provisioning server has prepared the subscription profile ordered by the MNO, and once the MNO signals that the subscription profile is ready to be used, the subscription profile is moved to a “released” state in the provisioning server. Once the subscription profile is downloaded and successfully installed to the communication device, the subscription profile moves to an “installed” state, which is the final state in the provisioning server from which there is not defined any further state transitions.

In addition to subscription related information, a subscription profile also comprises metadata. The metadata might be provided in terms of subscription profile Policy Rules (PPR) which define how the eSIM should react to certain events and conditions related to the subscription profile. The metadata might further comprise information related to notifications that should be sent by the eSIM, e.g. that when a subscription profile is deleted a notification should be sent (e.g.) to the provisioning server.

The provisioning server is provided with a download attempt counter for each subscription profile to protect against malicious download attempts. When the counter is exceeded the provisioning server informs the MNO.

Aspects of where subscription profiles are to be downloaded to a bulk of communication devices will now be disclosed. As an illustrative example, assume a scenario where an enterprise renting such a bulk of communication devices (e.g., network connectible equipment, such as network connectible lawnmowers, drills etc.) intends to use eSIM for these communication devices. This would imply that for each communication device there would have to be a dedicated subscription, or alternatively, for each time a communication device is rented a new subscription would have to be ordered, and then later terminated once the communication device is returned. The first alternative would require many extra, or unused, subscriptions to be maintain, which the enterprise might need to pay for as all the communication devices are typically never rented out at the same time but rather sit in a warehouse waiting to get rented. The latter alternative would be an optimization of the first alternative as subscriptions would be ordered and paid for on a per use basis. However, the second alternative would require additional overhead for each rental as the profiles cannot be ordered in advance. Also, preparing the subscription in the MNO and provisioning server might not be instantaneous, thus resulting in a time delay until the communication device can be rented.

Hence, in scenarios where subscription profiles are to be downloaded to a bulk of communication devices, the current schemes for subscription profile handling are inflexible, resulting in signalling overhead and/or delays before a communication device having an eSIM can be used for communication with the MNO.

Hence, there is still a need for improved techniques for download of subscription profiles to a bulk of communication devices.

### SUMMARY

An object of embodiments herein is to enable efficient download of subscription profiles to a bulk of communication devices such that the above disclosed issues are avoided, or at least mitigated or reduced.

According to a first aspect there is presented a method for handling download of a subscription profile from a pool of subscription profiles. The subscription profiles of the pool of subscription profiles are served by an MNO entity. The method is performed by a subscription management entity. The subscription management entity manages the pool of subscription profiles. The pool of subscription profiles has its own pool identifier. The method comprises obtaining a request from a communication device for download of one of the subscription profiles from the pool of subscription profiles. The pool identifier is obtained from the communication device as part of mutual authentication between the subscription management entity and the communication device. The method comprises enabling download to the communication device of one of the subscription profiles from the pool of subscription profiles upon having authenticated the communication device and bound a device identifier of the communication device to this one of the subscription profiles. The method comprises filling up the pool of subscription profiles so that total number of subscription profiles in the pool of subscription profiles remains unchanged upon having obtained an indication that this one of the subscription profiles has been deleted from the communication device.

According to a second aspect there is presented a subscription management entity for handling download of a subscription profile from a pool of subscription profiles. The subscription profiles of the pool of subscription profiles are served by an MNO entity. The subscription management entity manages the pool of subscription profiles. The pool of subscription profiles has its own pool identifier. The subscription management entity comprises processing circuitry. The processing circuitry is configured to cause the subscription management entity to obtain a request from a communication device for download of one of the subscription profiles from the pool of subscription profiles. The pool identifier is obtained from the communication device as part of mutual authentication between the subscription management entity and the communication device. The processing circuitry is configured to cause the subscription management entity to enable download to the communication device of one of the subscription profiles from the pool of subscription profiles upon having authenticated the communication device and bound a device identifier of the communication device to this one of the subscription profiles. The processing circuitry is configured to cause the subscription management entity to fill up the pool of subscription profiles so that total number of subscription profiles in the pool of subscription profiles remains unchanged upon having obtained an indication that this one of the subscription profiles has been deleted from the communication device.

According to a third aspect there is presented a subscription management entity for handling download of a subscription profile from a pool of subscription profiles. The subscription profiles of the pool of subscription profiles are served by an MNO entity. The subscription management entity manages the pool of subscription profiles. The pool of subscription profiles has its own pool identifier. The subscription management entity comprises an obtain module configured to obtain a request from a communication device for download of one of the subscription profiles from the pool of subscription profiles. The pool identifier is obtained from the communication device as part of mutual authentication between the subscription management entity and the communication device. The subscription management entity comprises an enable module configured to enable download to the communication device of one of the subscription profiles from the pool of subscription profiles upon having authenticated the communication device and bound a device identifier of the communication device to this one of the subscription profiles. The subscription management entity comprises a fill module configured to fill up the pool of subscription profiles so that total number of subscription profiles in the pool of subscription profiles remains unchanged upon having obtained an indication that this one of the subscription profiles has been deleted from the communication device.

According to a fourth aspect there is presented a computer program for handling download of a subscription profile from a pool of subscription profiles. The computer program comprises computer program code which, when run on processing circuitry of a subscription management entity, causes the subscription management entity to perform a method according to the first aspect.

According to a fifth aspect there is presented a method for ordering a pool of subscription profiles. The method is performed by an MNO entity. The method comprises providing an order to a subscription management entity for the subscription management entity to create a pool of subscription profiles. The pool of subscription profiles has its own pool identifier.

According to a sixth aspect there is presented an MNO entity for ordering a pool of subscription profiles. The MNO entity comprises processing circuitry. The processing circuitry is configured to cause the MNO entity to provide an order to a subscription management entity for the subscription management entity to create a pool of subscription profiles. The pool of subscription profiles has its own pool identifier.

According to a seventh aspect there is presented an MNO entity for ordering a pool of subscription profiles. The MNO entity comprises a provide module configured to provide an order to a subscription management entity for the subscription management entity to create a pool of subscription profiles. The pool of subscription profiles has its own pool identifier.

According to an eighth aspect there is presented a computer program for ordering a pool of subscription profiles, the computer program comprising computer program code which, when run on processing circuitry of an MNO entity, causes the MNO entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable efficient download of subscription profiles to a bulk of communication devices.

Advantageously, these aspects enable efficient download of subscription profiles to a bulk of communication devices without suffering from the above disclosed issues.

Advantageously, according to these aspects, ordering of temporary and reusable subscription profiles can be done in advance so the subscription profiles are available when a communication device needs to download a subscription profile. This can be done for a large number of communication devices whilst optimizing the amount of subscription profiles that need to be allocated, maintained, and paid for. In turn, this minimizes the needed signalling between the involved entities, especially the subscription management entity and the MNO entity.

Advantageously, these aspects can be used in scenarios where a large number of communication devices at random times need a temporary subscription profile.

Advantageously, these aspects enable several communication devices, such as communication devices in a mesh network, to take turns holding the same subscription profile, thereby sharing the power consumption load between the communication devices.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to embodiments;

FIGS. 2 and 3 are flowcharts of methods according to embodiments;

FIGS. 4, 5, 6, 7, and 8 are signalling diagrams according to embodiments;

FIG. 9 is a schematic diagram showing functional units of a subscription management entity according to an embodiment;

FIG. 10 is a schematic diagram showing functional modules of a subscription management entity according to an embodiment;

FIG. 11 is a schematic diagram showing functional units of an MNO entity according to an embodiment;

FIG. 12 is a schematic diagram showing functional modules of an MNO entity according to an embodiment; and

FIG. 13 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item or piece of information is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item or piece of information is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

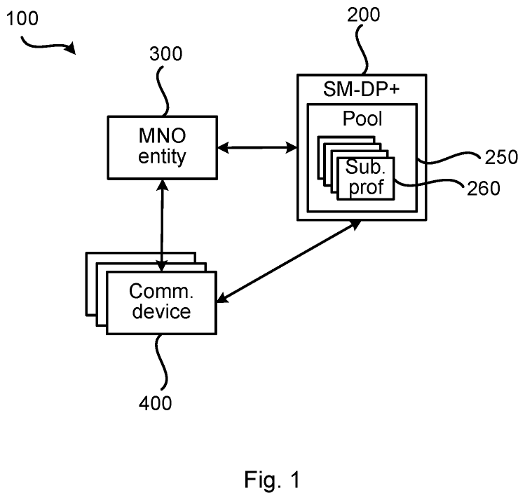

FIG. 1 is a schematic diagram illustrating a communication system 100 where embodiments presented herein can be applied. The communication system 100 comprises a subscription management entity 200, an MNO entity 300, and communication devices 400. The subscription management entity 200 manages a pool 250 of subscription profiles 260. The subscription management entity 200 might be an SM-DP+. The MNO entity 300 might be an eSIM management service entity. The communication devices 400 might be provided with an eSIM and be a user equipment, network equipment vehicle, network connectible equipment, wearable electronic device, or the like.

As noted above there is still a need for improved techniques for download of subscription profiles 260 to a bulk of communication devices 400.

The GSMA eSIM specification “SGP.22—RSP Technical Specification”, Version 2.2.2, 5 Jun. 2020, defines how an MNO entity 300 can order a profile to be prepared from an subscription management entity 200 in the form of an SM-DP+. The MNO entity 300 can provide the EID of the target communication device 400 or leave it out if not known in advance. It is noted that, according to the specification, the MNO entity 300 may request the subscription management entity 200 to create multiple subscription profiles in advance. However, no details are given except indicating that subscription profiles are not bound to EIDs at bulk order, i.e. EIDs are not provided by the MNO entity 300 at the profile order. According to the herein disclosed embodiments, the MNO entity 300 can request multiple subscription profiles from the subscription management entity 200 but, as will be further disclosed below, instead of including none or an equal number as requested subscription profiles, the MNO entity 300 can provide a larger number of EIDs to associate with the subscription profiles ordered, but without binding a specific EID to a specific subscription profile.

The embodiments disclosed herein in particular relate to mechanisms for handling download of a subscription profile 260 from a pool 250 of subscription profiles 260 and ordering a pool 250 of subscription profiles 260. In order to obtain such mechanisms there is provided a subscription management entity 200, a method performed by the subscription management entity 200, a computer program product comprising code, for example in the form of a computer program, that when run on processing circuitry of the subscription management entity 200, causes the subscription management entity 200 to perform the method. In order to obtain such mechanisms there is further provided an MNO entity 300, a method performed by the MNO entity 300, and a computer program product comprising code, for example in the form of a computer program, that when run on processing circuitry of the MNO entity 300, causes the MNO entity 300 to perform the method.

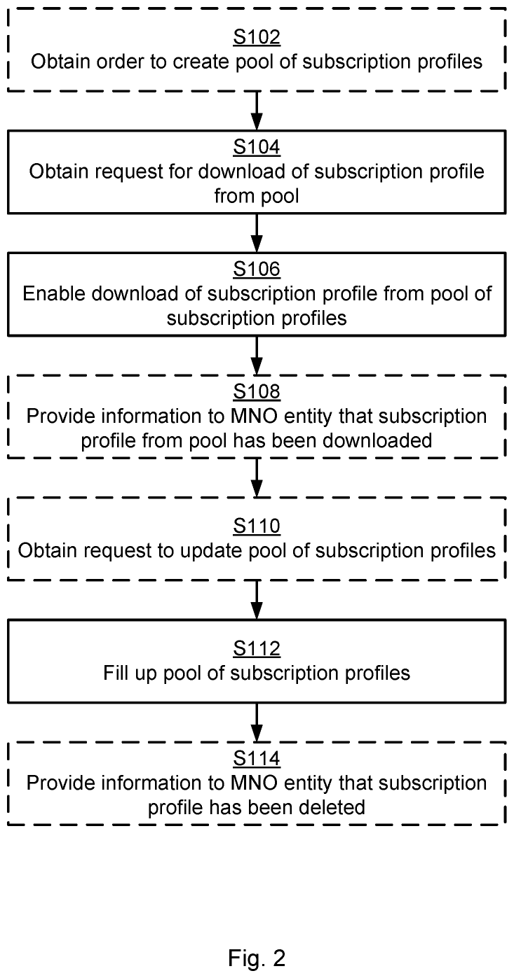

Reference is now made to FIG. 2 illustrating a method for handling download of a subscription profile 260 from a pool 250 of subscription profiles 260 as performed by the subscription management entity 200 according to an embodiment. The subscription profiles 260 of the pool 250 of subscription profiles 260 are served by an MNO entity 300. The subscription management entity 200 manages the pool 250 of subscription profiles 260. The pool 250 of subscription profiles 260 has its own pool identifier.

S104: The subscription management entity 200 obtains a request from a communication device 400 for download of one of the subscription profiles 260 from the pool 250 of subscription profiles 260. The pool identifier is obtained from the communication device 400 as part of mutual authentication between the subscription management entity 200 and the communication device 400.

S106: The subscription management entity 200 enables download to the communication device 400 of one of the subscription profiles 260 from the pool 250 of subscription profiles 260 upon having authenticated the communication device 400 and upon having bound a device identifier of the communication device 400 to this one of the subscription profiles 260.

S112: The subscription management entity 200, upon having obtained an indication that this one of the subscription profiles 260 has been deleted from the communication device 400, fills up the pool 250 of subscription profiles 260 so that the total number of subscription profiles 260 in the pool 250 of subscription profiles 260 remains unchanged.

Embodiments relating to further details of handling download of a subscription profile 260 from a pool 250 of subscription profiles 260 as performed by the subscription management entity 200 will now be disclosed.

There could be different types of pool identifiers. In some embodiments, the pool identifier is a matching ID (MID). The matching ID for the ordered subscription profiles 260 is the same for all subscription profiles 260 and could thereby act as a key to the pool 250.

In some aspects, the subscription management entity 200 receives an order for the pool 250 from the MNO entity 300. That is, in some embodiments, the subscription management entity 200 is configured to perform (optional) step S102:

S102: The subscription management entity 200 obtains an order from the MNO entity 300 for the subscription management entity 200 to create the pool 250 of subscription profiles 260. The pool 250 of subscription profiles 260 is then created by the subscription management entity 200 in response thereto (i.e., in response to having obtained the order).

In some aspects, the order is an implicit order for pool 250. Such an implicit order might be realized by the MNO entity 300 providing a mismatch in the number of ordered profiles and the number of provided EIDs. That is, in some embodiments, the order comprises zero or more device identifiers (or at least one such device identifier) of communication devices 400 to be associated with the subscription profiles 260. In the order, there is a mismatch between number of ordered subscription profiles 260 and number of device identifiers.

Such an implicit order might further be realized by the MNO entity 300 providing the same reference data for profile download, e.g. Matching ID, for all ordered subscription profiles. That is, in some embodiments, in the order, the same reference data for subscription profile download is provided for all ordered subscription profiles 260. The provided reference data for the subscription profile download might then also be used as the pool identifier.

An explicit order might be realized by a flag, or bit, being set by the MNO entity 300. That is, in some embodiments, in the order, a pool indicator is set to indicate that the order is for a pool 250 of subscription profiles 260. Alternatively, a dedicated interface or message type may be used for ordering the pool 250 of subscription profiles 260.

In some aspects, the MNO entity 300 updates the pool 250. Hence, in some embodiments, the subscription management entity 200 is configured to perform (optional) step S110:

S110: The subscription management entity 200 obtains a request from the MNO entity 300 for the subscription management entity 200 to update the pool 250 of subscription profiles 260. The request pertains to updating the pool 250 of subscription profiles 260 in terms of: number of subscription profiles 260 in the pool 250 of subscription profiles 260, and/or which communication devices 400 are allowed to download one of the subscription profiles 260 from the pool 250 of subscription profiles 260. In this respect, the number of subscription profiles 260 in the pool 250 of subscription profiles 260 could either imply an increase, thus increasing the pool size, or a decrease, thus decreasing the pool size, of the number of subscription profiles 260 in the pool 250 of subscription profiles 260.

Although a device identifier, such as an EID, might be provided in the order, the EID is not bound to a specific subscription profile 260. In some aspects, each pool 250 of subscription profiles 260 is associated with its own list of device identifiers, such as EIDs. That is, the pool 250 of subscription profiles 260 might be associated with a list of devices identifiers. Then, in some embodiments, only communication devices 400 having a device identifier in the list of devices identifiers is allowed to download one of the subscription profiles 260 from the pool 250 of subscription profiles 260.

In some aspects, the subscription management entity 200 verifies that the device identifier, such as EID, used in the mutual authentication is listed as associated with the pool 250. That is, in some embodiments, as part of mutual authentication between the subscription management entity 200 and the communication device 400, the subscription management entity 200 verifies that the communication device 400 has a device identifier in the list of devices identifiers.

In some aspects, the subscription management entity 200 verifies that the device identifier, such as EID, is not already holding a subscription profile from the pool 250. That is, in some embodiments, as part of mutual authentication between the subscription management entity 200 and the communication device 400, the subscription management entity 200 verifies that the communication device 400 does not possess a subscription profile 260 that has previously been downloaded from the pool 250 of subscription profiles 260.

In some aspects, the subscription management entity 200 informs the MNO entity 300 of successful download of the subscription profile 260. Hence, in some embodiments, the subscription management entity 200 is configured to perform (optional) step S108:

S108: The subscription management entity 200 provides information to the MNO entity 300 that this one of the subscription profiles 260 has been downloaded to the communication device 400. Optionally, the subscription management entity 200 also provides, to the MNO entity 300, the device identifier of the communication device 400 that downloaded the subscription profile 260.

In some aspects, the subscription management entity 200 informs the MNO entity 300 that the subscription profile 260 has been successfully deleted. Hence, in some embodiments, the subscription management entity 200 is configured to perform (optional) step S114:

S114: The subscription management entity 200 provides information to the MNO entity 300 that this one of the subscription profiles 260 has been deleted from the communication device 400.

There could be different ways for the subscription management entity 200 to fill up the pool 250 of subscription profiles 260 in step S112.

In some aspects, the pool 250 of subscription profiles 260 is filled up by means of states. In particular, in some embodiments, a state of this one of the subscription profiles 260 is changed from released to installed when this one of the subscription profiles 260 is downloaded and successfully installed. The pool 250 of subscription profiles 260 might then be filled up by the state being changed back from installed to released upon the subscription management entity 200 having obtained the indication that this one of the subscription profiles 260 has been deleted from the communication device 400.

Further, the count of download attempts for the subscription profile might be reset when the subscription profile 260 is released back to the pool 250. That is, in some embodiments, a counter specifying the number of download attempts of this one of the subscription profiles 260 is reset upon the state being changed back from installed to released.

Further, security critical parameters, such as secret key, might be changed when the subscription profile 260 is released back to the pool 250. That is, in some embodiments, each subscription profile 260 in the pool 250 of subscription profiles 260 has its own security parameters, and the security parameters of this one of the subscription profiles 260 are changed when the state is changed back from installed to released.

In some aspects, the pool 250 of subscription profiles 260 is filled up by means of new subscription profiles 260 being created. That is, in some embodiments, the pool 250 of subscription profiles 260 is filled up by this one of the subscription profiles 260 being deleted from the pool 250 of subscription profiles 260 and a new subscription profile 260 being added to the pool 250 of subscription profiles 260.

Details of the subscription profile 260 will now be disclosed.

In some aspects, each of the subscription profiles 260 is configured with usage limitations. In particular, in some embodiments, each of the subscription profiles 260 in the pool 250 of subscription profiles 260 is configured with a usage limitation in term of: point in time after download when the subscription profile 260 will be automatically deleted, and/or amount of data communicated by a given communication device 400 using the subscription profile 260 before the subscription profile 260 will be automatically deleted from this given communication device 400. Thus, the subscription profiles 260 in the pool 250 could be configured with usage limitations, e.g. time before subscription profile 260 will be automatically deleted, or amount of data that can be used before subscription profile 260 is automatically deleted.

In some aspects, each of the subscription profiles 260 comprises Notification Configuration Information that includes instructions that a notification is to be sent from the communication device 400 when the subscription profile is deleted. That is, in some embodiments, each of the subscription profiles 260 in the pool 250 of subscription profiles 260 is configured with instructions for a notification to be sent from a given communication device 400 upon the subscription as downloaded to this given communication device 400 is deleted from this given communication device 400.

In some aspects, each of the subscription profiles 260 comprises a Profile Policy Rule that states that the subscription profile will be deleted when disabled. That is, in some embodiments, each of the subscription profiles 260 in the pool 250 of subscription profiles 260 is configured with a policy according to which the subscription profile 260 as downloaded to a given communication device 400 is automatically deleted from this given communication device 400 when being disabled by this given communication device 400. This will prevent subscription profiles 260 from being dormant on a communication device 400. In examples where the communication device 400 is a user equipment, such as a mobile phone, that downloads a temporary subscription profile 260, once the temporary subscription profile 260 is deleted, the communication device 400 automatically reverts to a main subscription profile.

Reference is now made to FIG. 3 illustrating a method for ordering a pool 250 of subscription profiles 260 as performed by the MNO entity 300 according to an embodiment.

S202: The MNO entity 300 provides an order to a subscription management entity 200 for the subscription management entity 200 to create a pool 250 of subscription profiles 260. The pool 250 of subscription profiles 260 has its own pool identifier.

Embodiments relating to further details of ordering a pool 250 of subscription profiles 260 as performed by the MNO entity 300 will now be disclosed.

As disclosed above, there could be different types of pool identifiers. In some embodiments, the pool identifier is a matching ID (MID).

As disclosed above, in some aspects, the order is an implicit order for pool 250. Such an implicit order might be realized by a mismatch between the number of ordered profiles and the number of provided EIDs. That is, in some embodiments, the order comprises zero or more device identifiers (or at least one such device identifier) of communication devices 400 to be associated with the subscription profiles 260. In the order, there is a mismatch between number of ordered subscription profiles 260 and number of device identifiers.

As disclosed above, such an implicit order might further be realized by the MNO entity 300 providing the same reference data for profile download for all subscription profiles. That is, in some embodiments, in the order, the same reference data for subscription profile download is provided for all ordered subscription profiles 260. As disclosed above, the provided reference data for the subscription profile download might then also be used as the pool identifier.

As disclosed above, an explicit order might be realized by a flag, or bit, being set by the MNO entity 300. That is, in some embodiments, in the order, a pool indicator is set to indicate that the order is for a pool 250 of subscription profiles 260. Alternatively, a dedicated interface or message type may be used for ordering a pool.

As further disclosed above, in some aspects, the MNO entity 300 updates the pool 250. Hence, in some embodiments, the MNO entity 300 is configured to perform (optional) step S206:

S206: The MNO entity 300 provides a request to the subscription management entity 200 for the subscription management entity 200 to update the pool 250 of subscription profiles 260. The request pertains to updating the pool 250 of subscription profiles 260 in terms of: number of subscription profiles 260 in the pool 250 of subscription profiles 260, and/or which communication devices 400 are allowed to download one of the subscription profiles 260 from the pool 250 of subscription profiles 260.

As disclosed above, in some aspects, the subscription management entity 200 informs the MNO entity 300 of successful download of the subscription profile 260.

Hence, in some embodiments, the MNO entity 300 is configured to perform (optional) step S204:

S204: The MNO entity 300 obtains information from the subscription management entity 200 that one of the subscription profiles 260 has been downloaded to a communication device 400.

As disclosed above, in some aspects, the subscription management entity 200 informs the MNO entity 300 that the subscription profile 260 has been successfully deleted. Hence, in some embodiments, the MNO entity 300 is configured to perform (optional) step S208:

S208: The MNO entity 300 obtains information from the subscription management entity 200 that this one of the subscription profiles 260 has been deleted from the communication device 400.

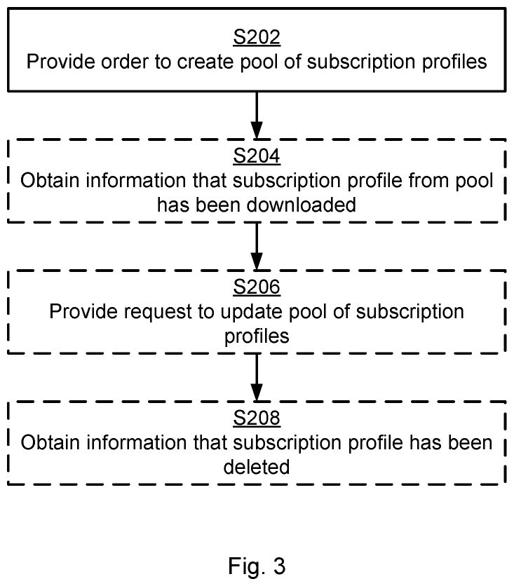

One particular embodiment for profile order based on at least some of the above disclosed embodiments will now be disclosed in detail with reference to the signalling diagrams of FIG. 4 and FIG. 5.

Profile order for one subscription profile 260 is shown in FIG. 4. It is noted that also other data, not affecting the hereinafter disclosed steps, can be exchanged between the subscription management entity 200 and the MNO entity 300 during this procedure.

S301: A profile download order, ES2+.DownloadOrder([EID], ProfileType or ICCID, POOL_INDICATION), is provided from the MNO entity 300 to the subscription management entity 200.

S302: The subscription management entity 200 reserves an ICCID (but if the ICCID is provided by MNO entity 300, the subscription management entity 200 uses the received value) but does not link any EID to ICCID.

S303: The subscription management entity 200 provides the ICCID to the MNO entity 300.

S304: The MNO entity 300 generates a Matching ID. If the subscription profile 260 is to be added to an existing pool 250 of subscription profiles 260, the Matching ID of the existing pool 250 is reused.

S305: The MNO entity 300 provides the Matching ID to the subscription management entity 200. It is possible that the subscription management entity 200 generates the Matching ID. In this case, the MNO entity 300 would not provide the Matching ID in step S305, which instead would be a trigger for the subscription management entity 200 to generate the Matching ID and then provide it back to the MNO entity 300.

The differences compared to a regular subscription profile order are that there is an indication that this is a pool-related subscription profile order, that the subscription management entity 200 does not link the (optionally) provided EID to the created subscription profile 260, and that the MNO entity 300 generates the Matching ID as identifier of the pool 250 (or if the pool 250 already is created the MNO entity 300 re-uses the Matching ID of the pool 250). If the pool 250 has already been created earlier, a subscription profile 260 would be added to the pool 250, and optionally also an EID would be added to the list of EIDs associated with the pool 250.

Profile order for a bulk order of subscription profiles 260 is shown in FIG. 5. It is noted that also other data, not affecting the hereinafter disclosed steps, can be exchanged between the subscription management entity 200 and the MNO entity 300 during this procedure.

S401: A profile download order, ES2+.DownloadOrder([EID(s)], ProfileTypes or ICCIDs, POOL_INDICATION), is provided from the MNO entity 300 to the subscription management entity 200.

S402: The subscription management entity 200 reserves ICCIDs but does not link any EIDs to the ICCIDs.

S403: The subscription management entity 200 provides the ICCIDs to the MNO entity 300.

S404: The MNO entity 300 generates one Matching ID for all the ICCIDs. If the subscription profiles 260 are to be added to an existing pool 250 of subscription profiles 260, the Matching ID of the existing pool 250 is reused. Alternatively, the subscription management entity 200 generates the Matching ID after step S405.

S405: The MNO entity 300 provides the Matching ID to the subscription management entity 200.

The differences compared to a regular subscription profile order as envisioned according to the aforementioned GSMA specification are that a list of EIDs is included in S401, and that there is an indication that the request pertains to a pool 250, that the EIDs are not be bound to specific subscription profiles 260 but rather added as EIDs associated with the pool 250, and that the MNO entity 300 generates one Matching ID for the whole pool 250 and provide this Matching ID to the subscription management entity 200.

One particular embodiment for update to a previous subscription profile order based on at least some of the above disclosed embodiments will now be disclosed in detail with reference to the signalling diagram of FIG. 6. It is noted that also other data, not affecting the hereinafter disclosed steps, can be exchanged between the subscription management entity 200 and the MNO entity 300 during this procedure.

The MNO entity 300 might update the pool 250, for example either by changing the number of subscription profiles 260 or by modifying the list of EIDs associated with the pool 250 of subscription profiles 260. In order to do so the MNO entity 300 addresses the pool 250 using the Matching ID as key to the pool 250. The MNO entity 300 connects to the subscription management entity 200, identifies the pool 250 to be update using the associated Matching ID and provides the requested changes to the pool 250 (e.g. add x number of subscription profiles 260, remove y number of subscription profiles 260, add EIDs [a,b,c], and/or remove EIDs [q,w,e].

S501: An order update, UpdatePool(MatchingID, ProfileTypes or ICCIDs to add, ProfileTypes/ICCIDs to delete, EIDs to add, EIDs to delete), is provided from the MNO entity 300 to the subscription management entity 200.

S502: The subscription management entity 200 updates the pool 250 according to the order update.

S503: The subscription management entity 200 verifies to the MNO entity 300 that the pool 250 has been updated by providing a message OK, [ICCIDs], to the MNO entity 300.

In FIG. 6 there is just one message, in step S501, for updating information related to the pool 250, with which subscription profiles 260 could be added or deleted from the pool 250 and EIDs could be added or deleted. The message is targeted to the pool 250 by the Matching ID included in the message. In practice, there could be dedicated messages for adding subscription profiles 260, removing subscription profiles 260, adding EIDs, and/or removing EIDs. A trusted and secure connection might be established between the MNO entity 300 and subscription management entity 200 before these messages are exchanged to protect the pool 250 from unauthorized entities modifying it.

One particular embodiment for subscription profile 260 download based on at least some of the above disclosed embodiments will now be disclosed in detail with reference to the signalling diagram of FIG. 7. It is noted that also other data, not affecting the hereinafter disclosed steps, can be exchanged between the subscription management entity 200, the MNO entity 300, and the communication device 400 during this procedure.

A communication device 400 whose EID is associated with the pool 250 is assumed to be provided with an activation code (AC), which is the same for all communication devices 400 associated with the pool 250, and thus also for all subscription profiles 260 in the pool 250. The AC contains the address of the subscription management entity 200 and the Matching ID. Using the information from the AC, the communication device 400 proceeds to connect to the indicated subscription management entity 200 to download a subscription profile 260.

S601: The communication device 400 mutually authenticates with the subscription management entity 200 using its EID and associated certificate.

S602: Based on the Matching ID provided by the communication device 400 during the mutual authentication, the subscription management entity 200 identifies the pool 250 from which the communication device 400 requests to download a subscription profile 260.

As the matching ID matches a pool 250 rather than an individual subscription profile 260, the subscription management entity 200 understands that this is a request to get a (random) subscription profile 260 from the indicated pool 250.

S603: The subscription management entity 200 verifies that the EID used in the mutual authentication is listed as an associated EID for the pool 250.

S604: Optionally, the subscription management entity 200 verifies that the EID is not already holding a subscription profile 260 from the pool 250.

The subscription management entity 200 might for this purpose have a counter, bit, or flag associated for each EID that indicates if the EID holds a subscription profile 260, or even a pointer to any subscription profile 260 currently being held by the EID.

S605: The subscription management entity 200 initiates a subscription profile download procedure. The subscription management entity 200 selects one of the available subscription profiles 260 from the pool 250, i.e. one in “released” state and binds this subscription profile 260 to the EID.

S606: Optionally, the subscription management entity 200 informs the MNO entity 300 of the successful installation of the subscription profile 260 to the communication device 400, also providing the EID to which the subscription profile 260 was installed.

The MNO entity 300 can use the information received in step S606 to gather statistics for the subscription profile 260; from when the subscription profile 260 has been installed to when it is deleted. The statistics can be linked to the EID given by the subscription management entity 200. Once the same subscription profile 260 is later installed to some other communication device 400, the new EID will be provided to the MNO entity 300 and the MNO entity 300 can separate the usage of the same subscription profile 260 between the different EIDs, or communication devices 400. In this way the usage of the subscription profile 260 can be linked to specific communication devices 400 (EIDs), e.g. for billing purposes, or other usage, or proof of usage or behavior.

According to the download procedure in FIG. 7 the subscription management entity 200 thus identifies the pool 250 based on the provided Matching ID, verifies that the requesting EID is associated with the pool 250, verifies that the EID is not already holding a subscription profile 260 from the pool 250, and notifies the MNO entity 300 of the EID-ICCID mapping so the MNO entity 300 knows which EID currently uses the specific subscription profile 260 identified by the ICCID.

One particular embodiment for subscription profile 260 deletion based on at least some of the above disclosed embodiments will now be disclosed in detail with reference to the signalling diagram of FIG. 8. It is noted that also other data, not affecting the hereinafter disclosed steps, can be exchanged between the subscription management entity 200, the MNO entity 300, and the communication device 400 during this procedure.

S701: Profile deletion is initiated for the subscription profile 260 on the communication device 400.

S702: A notification of the subscription profile 260 having been deleted is communicated to the subscription management entity 200.

S703: If the MNO entity 300 was informed of subscription profile installation (step 606 above), the subscription management entity 200 informs the MNO entity 300 that the subscription profile 260 has been successfully deleted so that the MNO entity 300 can terminate the data record for that EID. Either the MNO entity 300 itself keeps track of which subscription profiles 260 are in the pool 250 of subscription profiles 260, or the subscription management entity 200 includes an indication of the pool 250 in the notifications to the MNO entity 300.

S704: The subscription management entity 200 moves the subscription profile 260 from “installed” state to “released” state so that the subscription profile 260 now, again, will be available for download from the pool 250. Furthermore, the count of download attempts for the subscription profile 260 should be reset. Also, any subscription profile download state associated to the EID from which the subscription profile 260 was deleted will be cleared.

According to the delete procedure of FIG. 8 the subscription management entity 200 thus moves the deleted subscription profile 260 to “released” state, resets the download counter of the subscription profile 260, and reset subscription profile 260 state of the EID in the pool 250. Also, the subscription management entity 200 informs the MNO entity 300 that the subscription profile 260 was deleted so that MNO entity 300 can stop tracking and binding the use of the subscription profile 260 with the specific EID.

When a subscription profile 260 belonging to the pool 250 is deleted from the communication device 400 this will result in the pool 250 having one more subscription profile 260 available for download. Once a subscription profile 260 is deleted from the communication device 400 its state changes from “installed” to “released” and thereby the subscription profile 260 is moved from being a reserved subscription profile 260 in the pool 250 to an available subscription profile 260 in the pool 250. This means that the same subscription profile 260 can be re-used by some (possibly) other communication device 400, optionally with some parameters of the subscription profile 260 changed. An alternative is to have the deleted subscription profile 260 being explicitly deleted from both the pool 250 and the serving MNO entity 300, and instead generate a new replacing subscription profile 260 for the pool 250. This corresponds to the above disclosed embodiment where the pool 250 of subscription profiles 260 is filled up by one of the subscription profiles 260 being deleted from the pool 250 of subscription profiles 260 and a new subscription profile 260 being added to the pool 250 of subscription profiles 260. In further details, the subscription management entity 200 upon receiving a delete notification for the subscription profile 260 from the communication device 400, optionally, proceeds with deleting the subscription profile 260 from the pool 250, and then informs the MNO entity 300 of the delete event so that the MNO entity 300 can delete the subscription profile 260 form its systems and databases. The new subscription profile 260 replacing the deleted subscription profile 260 is either generated by the subscription management entity 200 or the MNO entity 300, and then added to the pool 250 as an available subscription profile 260, i.e. being in “released” state.

When receiving the delete notification the subscription management entity 200 could generate the new subscription profile 260 for the pool 250, and then inform the MNO entity 300 of the new subscription profile 260 and its parameters. This could, optionally, be done together with sending the delete notification to the MNO entity 300. The MNO entity 300 could then add the new subscription profile 260 to its systems and databases. Alternatively, the MNO entity 300, upon receiving the delete notification, orders a new subscription profile 260 for the pool 250 following the previously presented procedure for ordering a subscription profile 260, re-using the pool identifier as reference data for the subscription profile download.

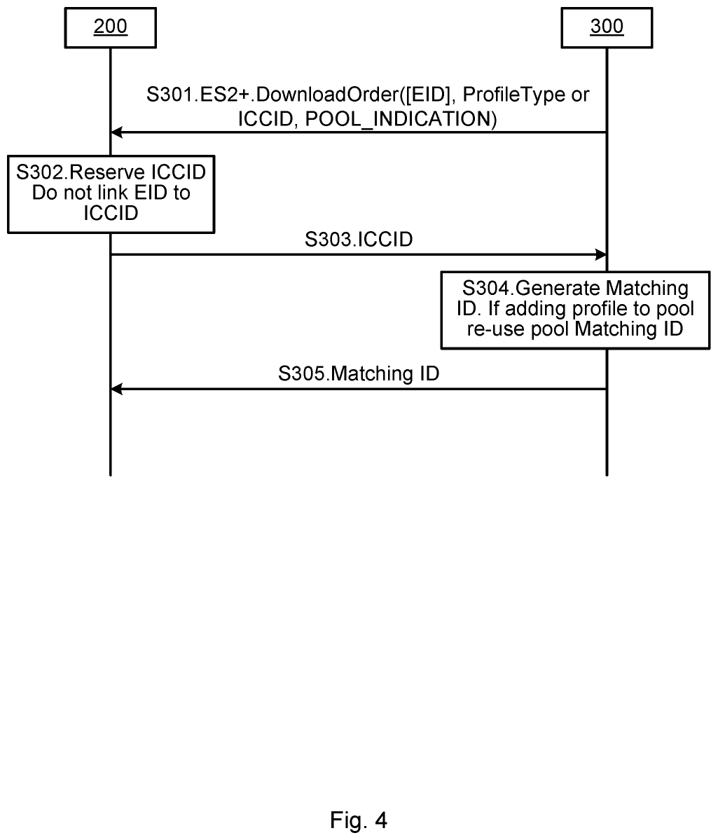

FIG. 9 schematically illustrates, in terms of a number of functional units, the components of a subscription management entity 200 according to an embodiment.

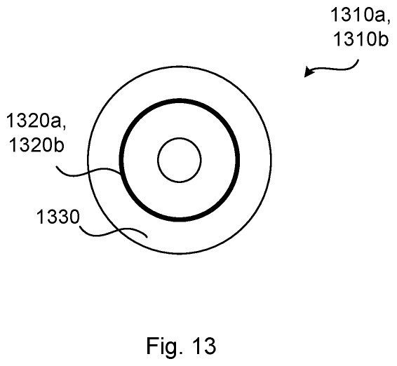

Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the subscription management entity 200 to perform a set of operations, or steps, as disclosed above. For example, the storage medium 230 may store the set of operations, and the processing circuitry 210 may be configured to retrieve the set of operations from the storage medium 230 to cause the subscription management entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The subscription management entity 200 may further comprise a communications interface 220 for communications with other entities, functions, nodes, and devices, as illustrated in FIG. 1. As such the communications interface 220 may comprise one or more transmitters and receivers, comprising analogue and digital components.

The processing circuitry 210 controls the general operation of the subscription management entity 200 e.g. by sending data and control signals to the communications interface 220 and the storage medium 230, by receiving data and reports from the communications interface 220, and by retrieving data and instructions from the storage medium 230. Other components, as well as the related functionality, of the subscription management entity 200 are omitted in order not to obscure the concepts presented herein.

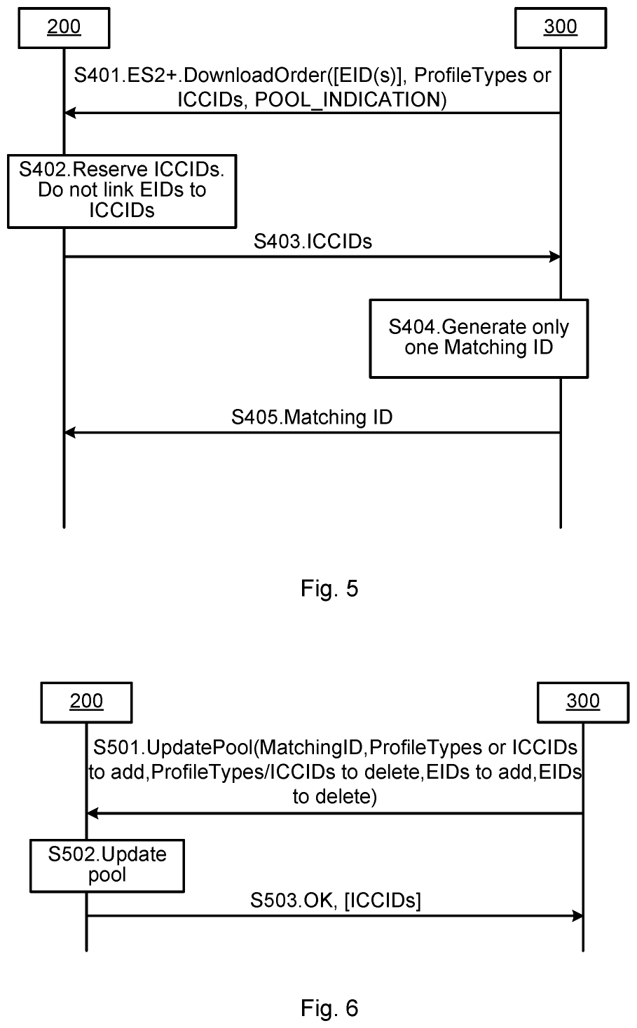

FIG. 10 schematically illustrates, in terms of a number of functional modules, the components of a subscription management entity 200 according to an embodiment. The subscription management entity 200 of FIG. 10 comprises a number of functional modules; an obtain module 210b configured to perform step S104, an enable module 210c configured to perform step S106, and a fill module 210f configured to perform step S112. The subscription management entity 200 of FIG. 10 may further comprise a number of optional functional modules, such as any of an obtain module 210a configured to perform step S102, a provide module 210d configured to perform step S108, an obtain module 210e configured to perform step S110, and a provide module 210g configured to perform step S114.

In general terms, each functional module 210a:210g may be implemented in hardware or in software. Preferably, one or more or all functional modules 210a:210g may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210g and to execute these instructions, thereby performing any steps of the subscription management entity 200 as disclosed herein.

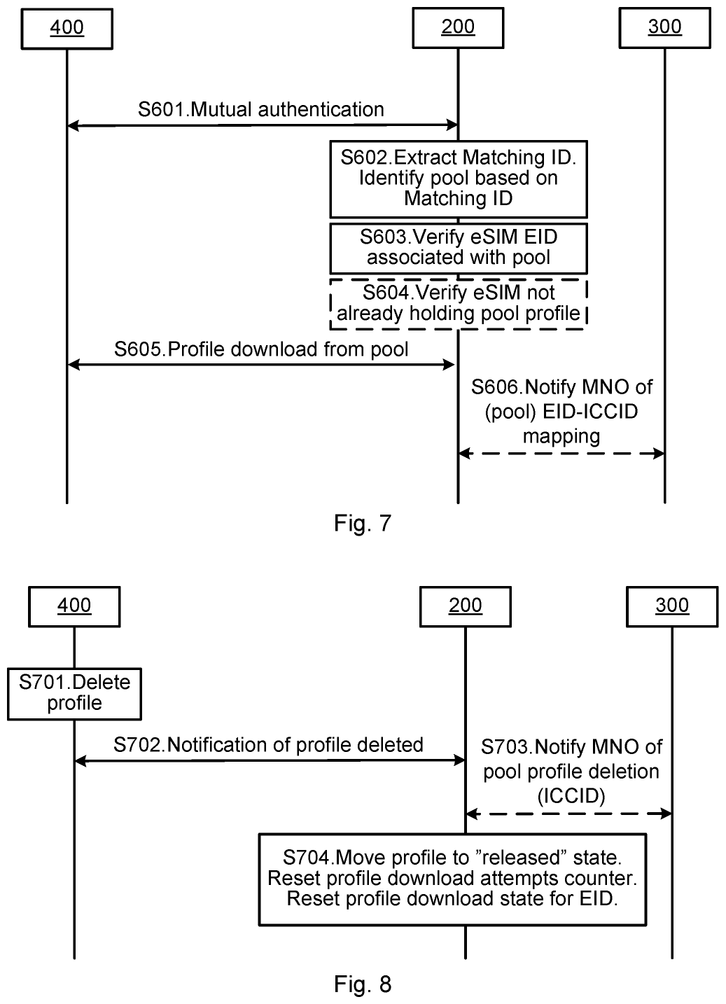

FIG. 11 schematically illustrates, in terms of a number of functional units, the components of an MNO entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the MNO entity 300 to perform a set of operations, or steps, as disclosed above. For example, the storage medium 330 may store the set of operations, and the processing circuitry 310 may be configured to retrieve the set of operations from the storage medium 330 to cause the MNO entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The MNO entity 300 may further comprise a communications interface 320 for communications with other entities, functions, nodes, and devices, as illustrated in FIG. 1. As such the communications interface 320 may comprise one or more transmitters and receivers, comprising analogue and digital components.

The processing circuitry 310 controls the general operation of the MNO entity 300 e.g. by sending data and control signals to the communications interface 320 and the storage medium 330, by receiving data and reports from the communications interface 320, and by retrieving data and instructions from the storage medium 330. Other components, as well as the related functionality, of the MNO entity 300 are omitted in order not to obscure the concepts presented herein.

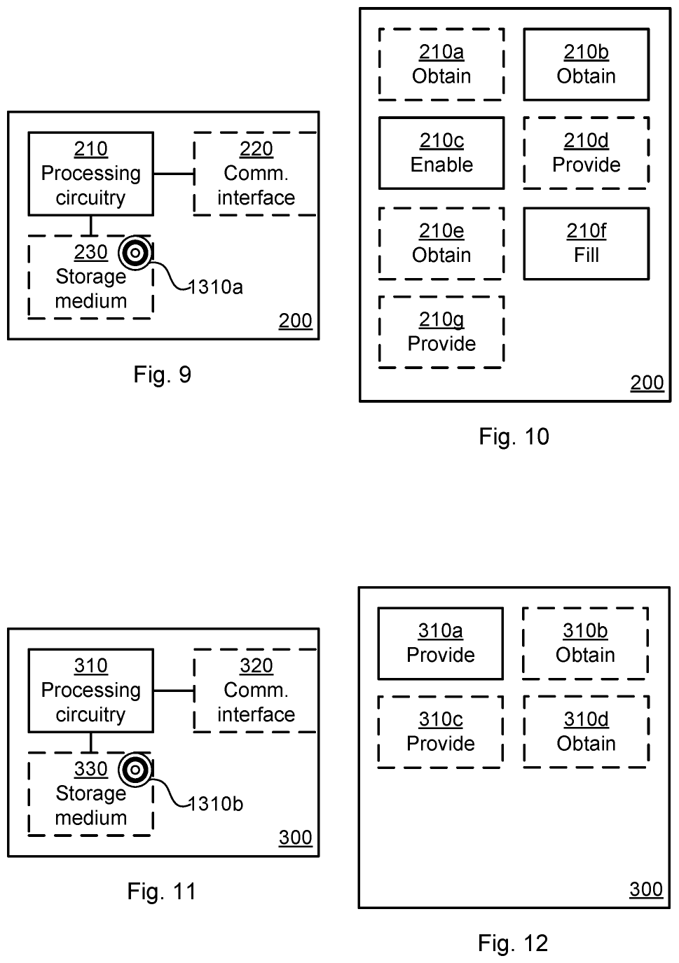

FIG. 12 schematically illustrates, in terms of a number of functional modules, the components of an MNO entity 300 according to an embodiment. The MNO entity 300 of FIG. 12 comprises a provide module 310a configured to perform step S202.

The MNO entity 300 of FIG. 12 may further comprise a number of optional functional modules, such as any of an obtain module 310b configured to perform step S204, a provide module 310c configured to perform step S206, an obtain module 310d configured to perform step S208.

In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the MNO entity 300 as disclosed herein.

The subscription management entity 200/MNO entity 300 may be provided as a standalone device or as a part of at least one further device. For example, the subscription management entity 200/MNO entity 300 may be provided in a node of a radio access network or in a node of a core network or in a node of a service network. Alternatively, functionality of the subscription management entity 200/MNO entity 300 may be distributed between at least two devices, or nodes. Thus, a first portion of the instructions performed by the subscription management entity 200/MNO entity 300 may be executed in a first device, and a second portion of the instructions performed by the subscription management entity 200/MNO entity 300 may be executed in a second device; the herein disclosed embodiments are not limited to any particular number of devices on which the instructions performed by the subscription management entity 200/MNO entity 300 may be executed. Hence, the methods according to the herein disclosed embodiments are suitable to be performed by a subscription management entity 200/MNO entity 300 residing in a cloud computational environment. Therefore, although a single processing circuitry 210, 310 is illustrated in FIGS. 9 and 11 the processing circuitry 210, 310 may be distributed among a plurality of devices, or nodes. The same applies to the functional modules 210a:210g, 310a:310d of FIGS. 10 and 12 and the computer programs 1320a, 1320b of FIG. 13.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the subscription management entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the MNO entity 300 as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling download of a subscription profile from a pool of subscription profiles, where the subscription profiles of the pool are served by a mobile network operator, MNO, entity, the method being performed by a subscription management entity, the subscription management entity managing the pool of subscription profiles, wherein the pool of subscription profiles has its own pool identifier, the method comprising:
obtaining a request from a communication device for download of one of the subscription profiles from the pool of subscription profiles, wherein the pool identifier is obtained from the communication device as part of mutual authentication between the subscription management entity and the communication device;
enabling download to the communication device of one of the subscription profiles from the pool of subscription profiles upon having authenticated the communication device and bound a device identifier of the communication device to said one of the subscription profiles; and
filling up the pool of subscription profiles so that total number of subscription profiles in the pool of subscription profiles remains unchanged upon having obtained an indication that said one of the subscription profiles has been deleted from the communication device.

2. The method according to claim 1, wherein the method further comprises:
obtaining an order from the MNO entity for the subscription management entity to create the pool of subscription profiles, and wherein the pool of subscription profiles is created by the subscription management entity in response thereto.

3. The method according to claim 2, wherein
the order comprises zero or more device identifiers of communication devices to be associated with the subscription profiles, and
in the order, (i) there is a mismatch between number of ordered subscription profiles and number of device identifiers, (ii) same reference data for subscription profile download is provided for all ordered subscription profiles, or (iii) a pool indicator is set to indicate that the order is for a pool of subscription profiles.

4-5. (canceled)

6. The method according to claim 1, wherein the method further comprises:
obtaining a request from the MNO entity for the subscription management entity to update the pool of subscription profiles in terms of: number of subscription profiles in the pool of subscription profiles, and/or which communication devices are allowed to download one of the subscription profiles from the pool of subscription profiles.

7. (canceled)

8. The method according to claim 1, wherein
the pool of subscription profiles is associated with a list of devices identifiers,
only communication devices having a device identifier in the list of devices identifiers is allowed to download one of the subscription profiles from the pool of subscription profiles, and
as part of mutual authentication between the subscription management entity and the communication device, the subscription management entity verifies that the communication device has a device identifier in the list of devices identifiers.

9. (canceled)

10. The method according to claim 1, wherein, as part of mutual authentication between the subscription management entity and the communication device, the subscription management entity verifies that the communication device does not possess a subscription profile that has previously been downloaded from the pool of subscription profiles.

11. The method according to claim 1, wherein the method further comprises:
providing information to the MNO entity that said one of the subscription profiles has been downloaded to the communication device and/or that said one of the subscription profiles has been deleted from the communication device.

12. (canceled)

13. The method according to claim 1, wherein a state of said one of the subscription profiles is changed from released to installed when said one of the subscription profiles is downloaded and successfully installed, and wherein the pool of subscription profiles is filled up by the state being changed back from installed to release upon the subscription management entity having obtained the indication that said one of the subscription profiles has been deleted from the communication device.

14. The method according to claim 13, wherein a counter specifying number of download attempts of said one of the subscription profiles is reset upon the state being changed back from installed to released.

15. The method according to claim 13, wherein each subscription profile in the pool of subscription profiles has its own security parameters, and wherein the security parameters of said one of the subscription profiles are changed when the state is changed back from installed to released.

16. The method according to claim 1, wherein the pool of subscription profiles is filled up by said one of the subscription profiles being deleted from the pool of subscription profiles and a new subscription profile being added to the pool of subscription profiles.

17. The method according to claim 1, wherein each of the subscription profiles in the pool of subscription profiles is configured with a usage limitation in term of: point in time after download when the subscription profile will be automatically deleted, and/or amount of data communicated by a given communication device using the subscription profile before the subscription profile will be automatically deleted from said given communication device.

18. The method according to claim 1, wherein each of the subscription profiles in the pool of subscription profiles is configured with:
instructions for a notification to be sent from a given communication device upon the subscription as downloaded to said given communication device is deleted from said given communication device, and/or
a policy according to which the subscription profile as downloaded to a given communication device is automatically deleted from said given communication device when being disabled by said given communication device.

19. (canceled)

20. A method for ordering a pool of subscription profiles, the method being performed by a mobile network operator, MNO, entity, the method comprising:
providing an order to a subscription management entity for the subscription management entity to create a pool of subscription profiles, wherein the pool of subscription profiles has its own pool identifier.

21. The method according to claim 20, wherein the order comprises zero or more device identifiers of communication devices to be associated with the subscription profiles, and wherein, in the order, there is a mismatch between number of ordered subscription profiles and number of device identifiers.

22. The method according to claim 20, wherein, in the order,
same reference data for subscription profile download is provided for all ordered subscription profiles (260), and/or
a pool indicator is set to indicate that the order is for a pool of subscription profiles.

23. (canceled)

24. The method according to claim 20, wherein the method further comprises:
providing a request to the subscription management entity for the subscription management entity to update the pool of subscription profiles in terms of: number of subscription profiles in the pool of subscription profiles, and/or which communication devices are allowed to download one of the subscription profiles from the pool of subscription profiles.

25. (canceled)

26. The method according to claim 20, wherein the method further comprises:
obtaining information from the subscription management entity that one of the subscription profiles has been downloaded to a communication device or deleted from the communication device.

27. (canceled)

28. A subscription management entity for handling download of a subscription profile from a pool of subscription profiles, where the subscription profiles of the pool of subscription profiles are served by a mobile network operator, MNO, entity, the subscription management entity managing the pool of subscription profiles, wherein the pool of subscription profiles has its own pool identifier, the subscription management entity comprising processing circuitry, the processing circuitry being configured to cause the subscription management entity to:
obtain a request from a communication device for download of one of the subscription profiles from the pool of subscription profiles, wherein the pool identifier is obtained from the communication device as part of mutual authentication between the subscription management entity and the communication device;
enable download to the communication device of one of the subscription profiles from the pool of subscription profiles upon having authenticated the communication device and bound a device identifier of the communication device to said one of the subscription profiles; and
fill up the pool of subscription profiles so that total number of subscription profiles in the pool of subscription profiles remains unchanged upon having obtained an indication that said one of the subscription profiles has been deleted from the communication device.

29-30. (canceled)

31. A mobile network operator, MNO, entity for ordering a pool of subscription profiles, the MNO entity comprising processing circuitry, the processing circuitry being configured to cause the MNO entity to:
provide an order to a subscription management entity for the subscription management entity to create a pool of subscription profiles, wherein the pool of subscription profiles has its own pool identifier.

32-36. (canceled)
